(19) United States
(12) Patent Application Publication
(10) Pub. No.: US 2023/0290248 A1
(43) Pub. Date: Sep. 14, 2023

(54) SYSTEM AND METHOD FOR DETECTING TRAFFIC FLOW WITH HEAT MAP

(71) Applicant: Continental Automotive Systems, Inc., Auburn Hills, MI (US)

(72) Inventors: Vivian Swan, Auburn Hills, MI (US); Ganesh Adireddy, Bloomfield Hills, MI (US)

(73) Assignee: Continental Automotive Systems, Inc., Auburn Hills, MI (US)

(21) Appl. No.: 17/654,285

(22) Filed: Mar. 10, 2022

(51) Int. Cl. G08G 1/0967; G08G 1/01

(52) U.S. Cl. CPC G08G 1/096716; G08G 1/0141; G08G 1/0145; G08G 1/0133; G08G 1/0116; G08G 1/096741; G08G 1/096783

(57) ABSTRACT

A method of investigation traffic flow includes receiving sensor data from at least one sensor describing a surface area within a field of view of at least one sensor. A current heat map is generated based on the sensor data. The current heat map is compared with a preexisting heat map of the surface area within the field of view. A MAP message is updated based on the comparison of the current heat map with the preexisting heat map.

### BACKGROUND

The present disclosure relates to a system and method for generating a traffic heat map associated with an area, for example, an intersection, road, or highway.

### SUMMARY

In one exemplary embodiment, a method of investigation traffic flow includes receiving sensor data from at least one sensor describing a surface area within a field of view of at least one sensor. A current heat map is generated based on the sensor data. The current heat map is compared with a preexisting heat map of the surface area within the field of view. A MAP message is updated based on the comparison of the current heat map with the preexisting heat map.

In another embodiment according to any of the previous embodiments, the heat map is compared to the preexisting heat map by identifying differences between the heat map and the preexisting heat map.

In another embodiment according to any of the previous embodiments, the differences between the heat map and the preexisting heat map include changes in traffic participant flow patterns.

In another embodiment according to any of the previous embodiments, the changes in traffic participant flow patterns include identifying at least one of a lane closure or a lane obstruction on the surface area.

In another embodiment according to any of the previous embodiments, the surface area includes a vehicle roadway.

In another embodiment according to any of the previous embodiments, the surface area includes a vehicle intersection.

In another embodiment according to any of the previous embodiments, the MAP message is transmitted to at least one traffic participant.

In another embodiment according to any of the previous embodiments, the sensor data from the at least one sensor corresponds to positions of the traffic participants within the field of view of the at least one sensor.

In another embodiment according to any of the previous embodiments, the at least one sensor includes at least one of radar, lidar, or optical.

In another embodiment according to any of the previous embodiments, comparing the current heat map to the preexisting heat map includes identifying a length of a lane closure on the surface area.

In another embodiment according to any of the previous embodiments, the MAP message is updated per a SAE standard.

In another embodiment according to any of the previous embodiments, the SAE standard is J2735.

In one exemplary embodiment, a traffic flow monitoring system for generating a heat map of a surface area includes a hardware processor and a hardware memory in communication with the hardware processor. The hardware memory storing instructions that when executed on the hardware processor cause the hardware processor to perform operations includes receiving sensor data from at least one sensor describing a surface area within a field of view of the at least one sensor. A current heat map is generated based on the sensor data. The current heat map is compared to a preexisting heat map of the surface area within the field of view. A MAP message is updated based on the comparison of the current heat map with the preexisting heat map.

In another embodiment according to any of the previous embodiments, the heat map is compared to the preexisting heat map includes identifying differences between the heat map and the preexisting heat map.

In another embodiment according to any of the previous embodiments, the differences between the heat map and the preexisting heat map include changes in traffic participant flow patterns.

In another embodiment according to any of the previous embodiments, the changes in traffic participant flow patterns include identifying at least one of a lane closure or a lane obstruction on the surface area.

In another embodiment according to any of the previous embodiments, the MAP message is updated per a SAE standard.

In another embodiment according to any of the previous embodiments, identifying traffic flow patterns on the surface area includes receiving sensor information from at least one sensor regarding positions of traffic participants in the field of view of the at least one sensor.

In another embodiment according to any of the previous embodiments, the at least one sensor includes at least one of radar, lidar, or optical.

In another embodiment according to any of the previous embodiments, comparing the current heat map to the preexisting heat map includes identifying a length of a lane closure on the surface area.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 is a schematic view of an exemplary over view of a vehicle-traffic system.

FIG. 2 is a schematic view of an exemplary heat map.

FIG. 3 is a schematic view of another exemplary heat map.

FIG. 4 illustrates an example method of investigation traffic flow.

### DESCRIPTION

Autonomous and semi-autonomous driving has been gaining interest in the past few years. To increase transportation safety of autonomous and semi-autonomous vehicles, it is important to have an accurate idea of the infrastructure (i.e., roads, lanes, intersections) that is being used by these vehicles. A vehicle-traffic system as described below quantifies this information as a heat map, which may be used by the autonomous and semi-autonomous vehicles to improve driving accuracy and thus transportation safety. Additionally, the heat may improve navigation for non-autonomous vehicles.

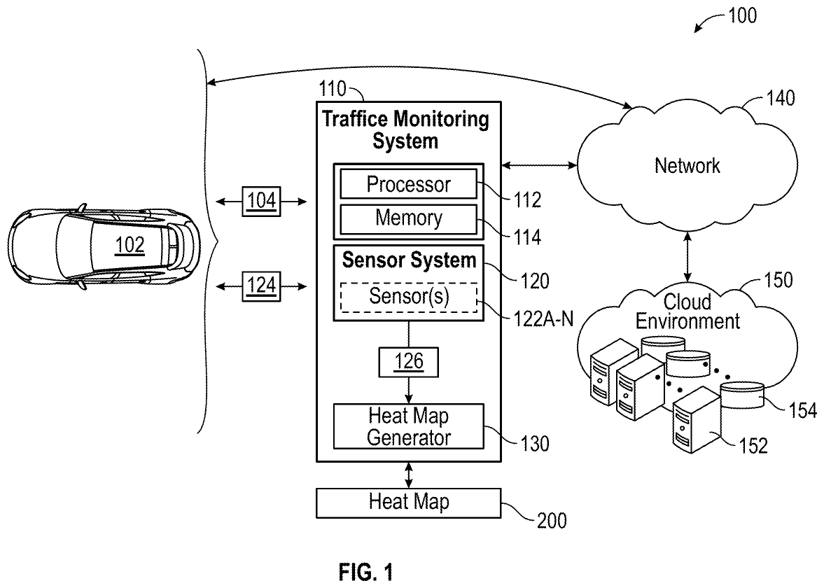

As shown in FIGS. 1, a vehicle-traffic system 100 includes a traffic monitoring system 110 that includes a computing device (or hardware processor) 112 (e.g., central processing unit having one or more computing processors) in communication with non-transitory memory or hardware memory 114 (e.g., a hard disk, flash memory, random-access memory) capable of storing instructions executable on the computing processor(s) 112. The traffic monitoring system 110 includes a sensor system 120. The sensor system 120 includes one or more sensors 122A-N positioned at one or more roads or road intersections, herein after referred to as a surface area, and configured to sense one or more traffic participants 102 or vehicles.

In some implementations, the one or more sensors 122A-N may be positioned to capture data 124 associated with surface area, where each sensor 122A-N captures data 124 associated with a portion of the surface area. As a result, the sensor data 124 associated with each sensor 122A-N includes sensor data 124 associated with the surface area. In some examples, the sensors 122A-N are positioned within the surface area, for example, each sensor 122A-N is positioned on a corner of the surface area such as an intersection, roadway, freeway, etc. to view the traffic participants 102 or supported by a traffic light.

The sensors 120 may include, but are not limited to, Radar, Sonar, LIDAR (Light Detection and Ranging, which can entail optical remote sensing that measures properties of scattered light to find range and/or other information of a distant target), HFL (High Flash LIDAR), LADAR (Laser Detection and Ranging), cameras (e.g., monocular camera, binocular camera). Each sensor 120 is positioned at a location where the sensor 120 can capture sensor data 124 associated with the traffic participants 102 at the specific location. Therefore, the sensor system 120 analyses the sensor data 124 captured by the one or more sensors 122. The analysis of the sensor data 124 includes the sensor system 120 identifying one or more traffic participants 102 and attributes 106 associated therewith.

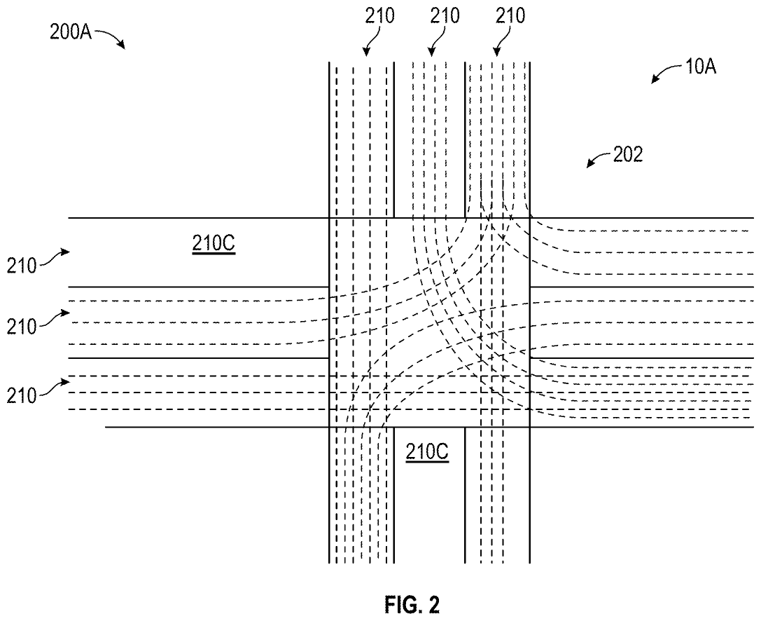

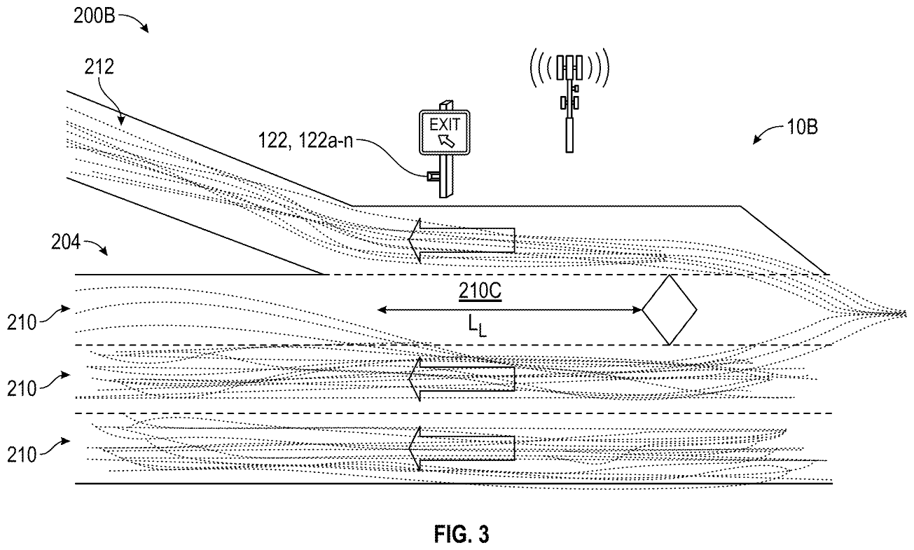

The traffic monitoring system 110 executes a heat map generator 130 that generates a heat map 200 as shown in FIGS. 2 and 3, based on the analyzed sensor data 126 received from the sensor system 120. Therefore, the sensors 122A-N capture sensor data 124 associated with the surface area, such as a road or intersection, then the sensor system 120 analyses the received sensor data 124. Following, the heat map generator 130 determines a traffic heat map 200 of the respective area based on the analyzed sensor data 126. The heat map 200 is based on an occurrence of the traffic participants 102 within the surface area surrounding an intersection and the heat map 200B is based on an occurrence of the traffic participants 102 traveling on a roadway.

As the number of traffic participants 102 increases within the surface area, a heat-index associated with the surface area increases as well. As shown in FIGS. 2 and 3, a pathway of each traffic participant 102 is shown, and the heat-index of each path increases when the number of traffic participants taking that path increases. No a-priori information about the surface area is needed by the traffic monitoring system 110 since all relevant information, such as sensor metadata (i.e., sensor location, for example, a relative position of each sensor 122A-N in a coordinate system and/or with respect to one another) associated with each sensor 122A-N are known and the received sensor data 124 is captured and collected. Therefore, the traffic monitoring system 110 generates the heat map 200 to understand the frequency of travel on vehicle pathways within the surface area.

From the heat map lanes, crosswalks and other information is extracted to compose a MAP message as per a SAE standard, such as the SAE J2735 standard. This MAP message is broadcasted over dedicated short range communication (“DSRC”) which is received by any DSRC receiver equipped vehicle and used accordingly. For example, the MAP message can be used in the receiving vehicle to: (a) recalculate the navigation route in an event of lane closure; (b) warn or indicate the driver about the changes; or (c) generate a new route as input for path planning in autonomous and semi-autonomous vehicles.

Vehicle-to-everything (V2X) communication is the flow of information from a vehicle to any other device, and vice versa. More specifically, V2X is a communication system that includes other types of communication such as, V2I (vehicle-to-infrastructure), V2V (vehicle-to-vehicle), V2P (vehicle-to-pedestrian), V2D (vehicle-to-device), and V2G (vehicle-to-grid). V2X is developed with the vision towards safety, mainly so that the vehicle is aware of its surroundings to help prevent collision of the vehicle with other vehicles or objects. In some implementations, the traffic monitoring system 110 communicates with the traffic participants 102 via V2X by way of a V2X communication 104.

In some examples, the traffic monitoring system 110 is in communication with a remote system 150 via the network 140. The remote system 150 may be a distributed system (e.g., a cloud environment) having scalable/elastic computing resources 152 and/or storage resources 154. The network 140 may include various types of networks, such as a local area network (LAN), wide area network (WAN), and/or the Internet. In some examples, the traffic monitoring system 110 executes on the remote system 150 and communicates with the sensors 122 via the network 140. In this case, the sensors 122 are positioned at the surface area to capture the sensor data 124. Additionally, in this case, the traffic participants 102 may communicate with the traffic monitoring system 110 via the network 140, such that the traffic participant 102 send the traffic monitoring system 110 one or more attributes 106 associated with the traffic participant 102.

In some implementations, the heat map generator 130 learns patterns of the traffic participants 102 based on the analyzed sensor data 126 received from the sensor system 120 (including the attributes 106 associated with each traffic participant 102). Additionally, in some examples, the heat map generator 130 determines a map of the surface area 10 based on the analyzed sensor data 126. For example, the heat map generator 130 determines a vehicle lane/pathways 210, based on an average of traffic participant attributes 106 in those lane limits by considering an occupancy probability threshold and cell movement probabilities. The heat map generator 130 may divide the heat map 200 into cells, and cell movement is indicative of the traffic participant 102 moving from one cell to another adjacent cell. The heat map generator 130 identifies one or more boundaries, such as the traffic lanes 210, based on the received sensor data 124.

The heat map generator 130 may store the heat map 200 in hardware memory 114 and continuously update the heat map 200 while receiving sensor data 124. Additionally, the heat map generator 130 analyses the heat map 200 over time and generates traffic data and traffic patterns associated with the traffic participants 102 based on the stored heat maps 200.

FIG. 2 illustrates a heat map 200A of an intersection 202 within the field of view 10A. The intersection 202 includes multiple traffic lanes 210 and the heat map 200A shows the frequency of travel along the lanes 210 at the intersection 202. In the illustrated example, the heat map 200A is overlaid on the graphical representation of the intersection 202 to show the frequency of travel of the vehicles 102 along the specific lanes 210 at the intersection 202. However, the heat map 200A need not be overlaid over a graphical representation of the intersection 202.

In the illustrated example of FIG. 2, the heat map 200A shows that a lane 210C is closed by the lack of traffic participants 102 traveling in that lane represented on the heat map 200A. The closure of lane 210C is also reflected in the lack of traffic participants 102 present traveling in a closed left turn lane 210C onto the closed lane 210C. The hardware processor 112 can utilize this information gained from the heat map 200A to provide updated information to a navigation system for the traffic participant 102 that may have intended to travel along the closed lane 210C.

FIG. 3 illustrates a heat map 200B of a roadway 204, such as a highway or freeway, having an exit ramp 212 located within a field of view 10B. The roadway 204 includes multiple lanes 210 traveling in a common direction with one of the lanes 210C being closed for a length L. The heat map 200A shows the frequency of travel along the lanes 210 of the roadway 204. In the illustrated example, the heat map 200B is overlaid on the graphical representation of the roadway 204 to show the frequency of travel of the traffic participants 102 along the specific lanes 210 on the roadway 204. However, the heat map 200B need not be overlaid over a graphical representation of the roadway 204.

In the illustrated example of FIG. 3, the heat map 200B shows that a lane 210C is closed in the vicinity of the exit ramp 212 by the lack of traffic participants 102 traveling in that lane represented on the heat map 200B. The hardware processor 112 can utilize this information gained from the heat map 200B to provide updated information to a navigation system for the traffic participant 102 that may have intended to travel along the closed lane 210C. The navigation system can also use the information from the hardware processor 112 to determine if the traffic participant 102 should be routed off of the roadway 204 at the exit ramp 212 or maintain traveling along one of the lanes 210 on the roadway 204 that is open by determining a length L of the closed lane 210C and identifying a heat index level of the remaining lanes 210 that are open. The impact of the closed lane 210C can also be determined from the heat map 200 by comparing a heat index of the roadway in the vicinity of the closed lane 210C at a current time to a heat index of the roadway in the vicinity of the closed lane 210C on an average basis or to a specific time on previous days.

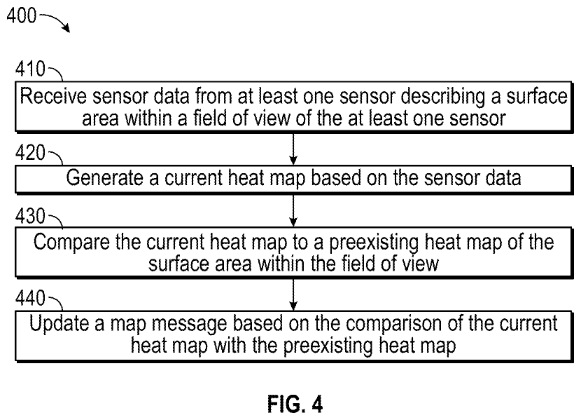

FIG. 4 illustrates a method 400 a method of investigating traffic flow. In order to investigate the traffic flow, the sensor data is received from at least one sensor 122A-N describing a surface area, such as a roadway or intersection, within the field of view 10 of the at least one sensor 122A-N. (Block 410). The sensor data is used to generate a current heat map based on the sensor data. (Block 420). The current heat map is compared with a preexisting heat map of the surface area within the field of view. (Block 430). The processor 112 or the cloud environment 150 can compare the current heat map 200 to the preexisting heat map 200 of the surface area within the field of view 10 to update a MAP message based on the comparison of the current heat map with the preexisting heat map. (Block 440).

Comparing the heat map 200 to the preexisting heat map 200 in Block 440 includes identifying differences between the heat map 200 and the preexisting heat map 200 of the surface area. This comparison is used to identify any changes in traffic participant flow pattern. If any changes are detected, a MAP message generator extracts all the necessary information from current heat map to update a preexisting MAP message to comply with a SAE standard, such as SAE J2735 standard. If this is the first-time a heat map is created, a new MAP message is composed using information from heat map without performing a comparison to a preexisting heat map.

One feature of identifying differences between the current heat map 200 to the preexisting heat map 200, is an improvement in the accuracy of changes in traffic participant flow patterns along a predetermined navigation pathway within the field of view 10. The navigation pathway can include a predetermined route along the surface area. For example, by identifying that the navigation pathway is no longer in use, an updated navigation pathway can be generated to avoid the area no longer in use. Additionally, one feature of the method described herein is improved accuracy in identifying a specific location of an accident, lane closure, or object blocking a lane 210 that is not available with current systems.

Furthermore, the method 400 described herein can be used to update the navigation pathway to direct traffic participants 102 to areas with a lower heat intensity on the heat map 200 to reduce traffic congestion and increase spacing between traffic participants 102 traveling on the lanes 210 by distributing the traffic participants 102 more evenly over the lanes 210.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of investigation traffic flow, the method comprising:
receiving sensor data from at least one sensor describing a surface area within a field of view of at least one sensor;
generating a current heat map based on the sensor data;
comparing the current heat map with a preexisting heat map of the surface area within the field of view; and
updating a MAP message based on the comparison of the current heat map with the preexisting heat map.

2. The method of claim 1, wherein comparing the heat map to the preexisting heat map includes identifying differences between the heat map and the preexisting heat map.

3. The method of claim 2, wherein the differences between the heat map and the preexisting heat map include changes in traffic participant flow patterns.

4. The method of claim 3, wherein the changes in traffic participant flow patterns include identifying at least one of a lane closure or a lane obstruction on the surface area.

5. The method of claim 2, wherein the surface area includes a vehicle roadway.

6. The method of claim 2, wherein the surface area includes a vehicle intersection.

7. The method of claim 2, further comprising transmitting the MAP message to at least one traffic participant.

8. The method of claim 2, wherein the sensor data from the at least one sensor corresponds to positions of the traffic participants within the field of view of the at least one sensor.

9. The method of claim 8, wherein the at least one sensor includes at least one of radar, lidar, or optical.

10. The method of claim 2, wherein comparing the current heat map to the preexisting heat map includes identifying a length of a lane closure on the surface area.

11. The method of claim 1, wherein the MAP message is updated per a SAE standard.

12. The method of claim 11, wherein the SAE standard is J2735.

13. A traffic flow monitoring system for generating a heat map of a surface area, the system comprising:
a hardware processor; and
hardware memory in communication with the hardware processor, the hardware memory storing instructions that when executed on the hardware processor cause the hardware processor to perform operations comprising:
receiving sensor data from at least one sensor describing a surface area within a field of view of the at least one sensor;
generating a current heat map based on the sensor data;
comparing the current heat map to a preexisting heat map of the surface area within the field of view; and
updating a MAP message based on the comparison of the current heat map with the preexisting heat map.

14. The system of claim 13, comparing the heat map to the preexisting heat map includes identifying differences between the heat map and the preexisting heat map.

15. The system of claim 14, wherein the differences between the heat map and the preexisting heat map include changes in traffic participant flow patterns.

16. The system of claim 15, wherein the changes in traffic participant flow patterns include identifying at least one of a lane closure or a lane obstruction on the surface area.

17. The system of claim 13, wherein the MAP message is updated per a SAE standard.

18. The system of claim 13, wherein identifying traffic flow patterns on the surface area includes receiving sensor information from at least one sensor regarding positions of traffic participants in the field of view of the at least one sensor.

19. The system of claim 18, wherein the at least one sensor includes at least one of radar, lidar, or optical.

20. The system of claim 13, wherein comparing the current heat map to the preexisting heat map includes identifying a length of a lane closure on the surface area.
